(19) United States
(12) Patent Application Publication
(10) Pub. No.: US 2019/0186108 A1
(43) Pub. Date: Jun. 20, 2019

(54) EARTH AND SAND ABRASION RESISTANT COMPONENT AND METHOD FOR PRODUCING THE SAME

(71) Applicant: KOMATSU LTD., Tokyo (JP)

(72) Inventors: Yasuhisa TSUKAMOTO, Tokyo (JP); Masaharu AMANO, Tokyo (JP); Takashi NAGAO, Tokyo (JP)

(73) Assignee: KOMATSU LTD., Tokyo (JP)

(21) Appl. No.: 16/323,768

(22) PCT Filed: Sep. 26, 2017
(86) PCT No.: PCT/JP2017/034636

§ 371 Date: Feb. 6, 2019

(30) Foreign Application Priority Data
Sep. 30, 2016 (JP) 2016-194684

(51) Int. Cl. E02F 9/28; B23K 9/04

(52) U.S. Cl. CPC E02F 9/285; B22D 19/06; B23K 9/044; E02F 9/2883

(57) ABSTRACT

A tooth as the earth and sand abrasion resistant component includes a base, a first overlay layer disposed in contact with the base so as to cover a distal end face which is a part of a surface of the base, and a second overlay layer disposed on the first overlay layer. The first overlay layer and the second overlay layer each include a matrix made of iron or steel, and cermet particles made of cermet and dispersed in the matrix.

### TECHNICAL FIELD

The present invention relates to an earth and sand abrasion resistant component and a method for producing the component.

### BACKGROUND ART

Hydraulic excavators, bulldozers, wheel loaders, and other work machines that operate in an environment where earth and sand exist have earth and sand abrasion resistant components such as teeth or ripping tips as their constituent components. In such an earth and sand abrasion resistant component, an overlay may be formed in a region requiring particularly high earth and sand abrasion resistance. As the overlay, for example, one having a matrix made of steel, with hard particles dispersed therein, may be adopted. Such an overlay can be formed by overlaying welding, for example. As the material constituting the hard particles, cemented carbide having tungsten carbide (WC) as its main component, for example, may be adopted (see, for example, Japanese Patent Application Laid-Open No. H8-47774 (Patent Literature 1), Japanese Patent Application Laid-Open No. 2007-268552 (Patent Literature 2), Japanese Patent Application Laid-Open No. 2008-762 (Patent Literature 3), and Japanese Patent Application Laid-Open No. 2008-763 (Patent Literature 4)). When the above-described cemented carbide is adopted as the material constituting the hard particles, WC having a high hardness is included in the overlay, and further, tungsten (W) and carbon (C) are eluted into the matrix, leading to an increased hardness of the matrix. As a result, an overlay having high earth and sand abrasion resistance can be formed.

### CITATION LIST

### Patent Literature

Patent Literature 1: Japanese Patent Application Laid-Open No. H8-47774

Patent Literature 2: Japanese Patent Application Laid-Open No. 2007-268552

Patent Literature 3: Japanese Patent Application Laid-Open No. 2008-762

Patent Literature 4: Japanese Patent Application Laid-Open No. 2008-763

### SUMMARY OF INVENTION

### Technical Problem

However, even the component having an overlay for which cemented carbide has been adopted as the material constituting the hard particles may not be able to offer sufficient resistance to earth and sand abrasion.

An object of the present invention is to provide an earth and sand abrasion resistant component that offers excellent earth and sand abrasion resistance.

### Solution to Problem

An earth and sand abrasion resistant component according to the present invention includes: a base; a first overlay layer disposed in contact with the base so as to cover a covered region being a part of a surface of the base; and a second overlay layer disposed on the first overlay layer. The first overlay layer and the second overlay layer each include a matrix made of iron or steel, and hard particles made of cermet and dispersed in the matrix.

As used herein, cermet refers to a composite material having particles of one or more ceramics selected from the group consisting of titanium carbide (TiC), titanium nitride (TiN), and titanium carbonitride (TiCN) sintered with metal as a binder, with the ceramic particles accounting for at least 50% by mass. It should be noted that the cermet herein does not include a composite material having WC particles sintered with metal as a binder, with the WC particles accounting for at least 50% by mass. As used herein, cemented carbide refers to a composite material having WC particles sintered with metal as a binder, with the WC particles accounting for at least 50% by mass.

The present inventors studied how to improve earth and sand abrasion resistance when such abrasion resistance cannot be obtained sufficiently even when an overlay is formed adopting cemented carbide as the material constituting the hard particles. As a result, they have found the following and reached the present invention.

In the case where sufficient earth and sand abrasion resistance cannot be obtained even by forming an overlay adopting cemented carbide as the material constituting the hard particles, a plurality of overlay layers may be formed by overlaying welding, for example, to increase the thickness of the overlay. However, earth and sand abrasion resistance does not improve with this approach, conceivably for the following reasons.

When cemented carbide is adopted as the material constituting the hard particles, the constituent elements would likely be eluted into the matrix, as described above, leading to an increased hardness of the matrix. In this case, although the matrix having the cemented carbide adopted as the material constituting the hard particles may become high in hardness, the matrix becomes brittle. Particularly in the case where a plurality of overlay layers are formed and stacked by overlaying welding, the boundary region between the lower overlay layer and the upper overlay layer is heated again during the formation of the upper overlay layer. This increases the amount of W and C eluted into the matrix, making the matrix harder and more brittle.

Further, with W and C eluted into the matrix, the hardness of the hard particles decreases. For example, while the hard particles made of cemented carbide originally have a hardness of about 1500 to 2000 HV, the hardness of the particles decreases to about 1000 HV. Therefore, in the case where a plurality of overlay layers are formed adopting cemented carbide as the material constituting the hard particles, while the hardness of the matrix increases, the matrix becomes brittle and the hardness of the hard particles decreases. As a result, although the matrix having a high hardness may more contribute to earth and sand abrasion resistance, the overlay would more likely suffer chipping or the like during the use of the earth and sand abrasion resistant component. Further, with the hard particles having a decreased hardness, contribution of the hard particles to earth and sand abrasion resistance becomes small. Still further, cracking may occur in the overlay during the formation of the overlay due to W and C eluted into the matrix. As explained above, forming a plurality of overlay layers adopting cemented carbide as the material constituting the hard particles would not lead to improved earth and sand abrasion resistance.

In contrast, in the earth and sand abrasion resistant component in the present invention, a plurality of overlay layers (first and second overlay layers) are formed and stacked, and cermet is adopted as the material constituting the hard particles. In the case where cermet is adopted as the material constituting the hard particles, the hard cermet particles are dispersed in the overlay, and the amount of the constituent elements eluted into the matrix becomes smaller than in the case where cemented carbide is adopted. Accordingly, the matrix of the overlay with cermet adopted as the material constituting the hard particles offers superior toughness, although it is smaller in hardness than the matrix of the overlay with cemented carbide adopted.

Further, as the amount of the constituent elements (Ti, C, and N) eluted into the matrix is small, the decrease in hardness of the hard particles is small. For example, the hard particles made of cermet originally having a hardness of about 1500 to 2000 HV maintain a hardness of about 1500 HV. Therefore, in the case of forming a plurality of overlay layers adopting cermet as the material constituting the hard particles, while the increase in hardness of the matrix is small, the matrix becomes excellent in toughness, and the decrease in hardness of the hard particles is restricted. As a result, although the contribution of the matrix to the earth and sand abrasion resistance does not increase considerably, occurrence of chipping of the overlay or the like during the use of the earth and sand abrasion resistant component is suppressed. With the decrease in hardness prevented, the hard particles contribute significantly to earth and sand abrasion resistance. Furthermore, cracking of the overlay during the formation of the overlay due to elution of the constituent elements into the matrix is also suppressed. In this manner, earth and sand abrasion resistance can be improved by forming a plurality of overlay layers adopting cermet as the material constituting the hard particles. Further, the matrix is prevented from becoming brittle, so it is readily possible to further improve the earth and sand abrasion resistance by increasing the number of overlay layers stacked.

As described above, according to the earth and sand abrasion resistant component of the present invention, it is possible to provide an earth and sand abrasion resistant component that is highly resistant to earth and sand abrasion.

In the earth and sand abrasion resistant component described above, in a region including an interface between the first overlay layer and the second overlay layer, the matrix may have a Vickers hardness that is not more than a half of a Vickers hardness of the hard particles. By restricting the Vickers hardness of the matrix to a half or less of that of the hard particles, the toughness of the matrix can further be improved.

In the earth and sand abrasion resistant component described above, the earth and sand abrasion resistant component may be a tooth, and the covered region may be located in a region in the base corresponding to a distal end portion of the tooth.

The tooth is an earth and sand abrasion resistant component that is attached to a bucket of a hydraulic excavator or the like and penetrates into earth and sand. The distal end is used in an extremely harsh environment where it is subject to earth and sand abrasion. Applying the inventive earth and sand abrasion resistant component to such a tooth makes it possible to provide a tooth excellent in earth and sand abrasion resistance.

A method for producing an earth and sand abrasion resistant component according to the present invention includes the steps of: preparing a base; forming a first overlay layer to cover a covered region being a part of a surface of the base; and forming a second overlay layer on the first overlay layer. The step of forming the first overlay layer and the step of forming the second overlay layer include forming, by overlaying welding, the first overlay layer and the second overlay layer each including a matrix made of iron or steel and hard particles made of cermet and dispersed in the matrix.

In the method for producing an earth and sand abrasion resistant component in the present invention, cermet is adopted as the material constituting the hard particles, and a plurality of overlay layers are formed and stacked by overlaying welding. Thus, the overlay layers having the hard cermet particles dispersed therein and offering excellent toughness are formed in a stacked manner. As a result, an earth and sand abrasion resistant component excellent in earth and sand abrasion resistance can be produced.

### Effects of Invention

As is clear from the above description, according to the earth and sand abrasion resistant component of the present invention, it is possible to provide an earth and sand abrasion resistant component that is highly resistant to earth and sand abrasion.

### BRIEF DESCRIPTION OF DRAWINGS

FIG. 1 is a schematic perspective view showing a structure of a bucket of a hydraulic excavator;

FIG. 2 is a schematic plan view showing a structure of a tooth;

FIG. 3 is a schematic cross-sectional view taken along the line in FIG. 2;

FIG. 4 is a schematic cross-sectional view showing, in an enlarged view, a portion of the tooth including its distal end;

FIG. 5 is a flowchart schematically illustrating steps for producing a tooth;

FIG. 6 is a schematic cross-sectional view illustrating a method for producing an overlay;

FIG. 7 includes photographs showing an appearance of test pieces each formed by stacking three overlay layers including cermet particles;

FIG. 8 includes photographs showing a cross section of the test pieces each formed by stacking three overlay layers including cermet particles;

FIG. 9 illustrates hardness distribution in a thickness direction of the overlays each including cermet particles and formed with three layers stacked;

FIG. 10 is a photograph showing an appearance of a test piece formed by stacking three overlay layers including cemented carbide particles;

FIG. 11 illustrates hardness distribution in a thickness direction of the overlay including cemented carbide particles and formed with three layers stacked;

FIG. 12 includes an optical micrograph of a cermet particle and a matrix surrounding the particle, and a diagram illustrating hardness distribution in a region corresponding to the field of view of the optical micrograph; and

FIG. 13 includes an optical micrograph of a cemented carbide particle and a matrix surrounding the particle, and a diagram illustrating hardness distribution in a region corresponding to the field of view of the optical micrograph.

### DESCRIPTION OF EMBODIMENTS

An embodiment of the present invention will now be described. In the following drawings, the same or corresponding parts are denoted by the same reference numerals, and the description thereof will not be repeated.

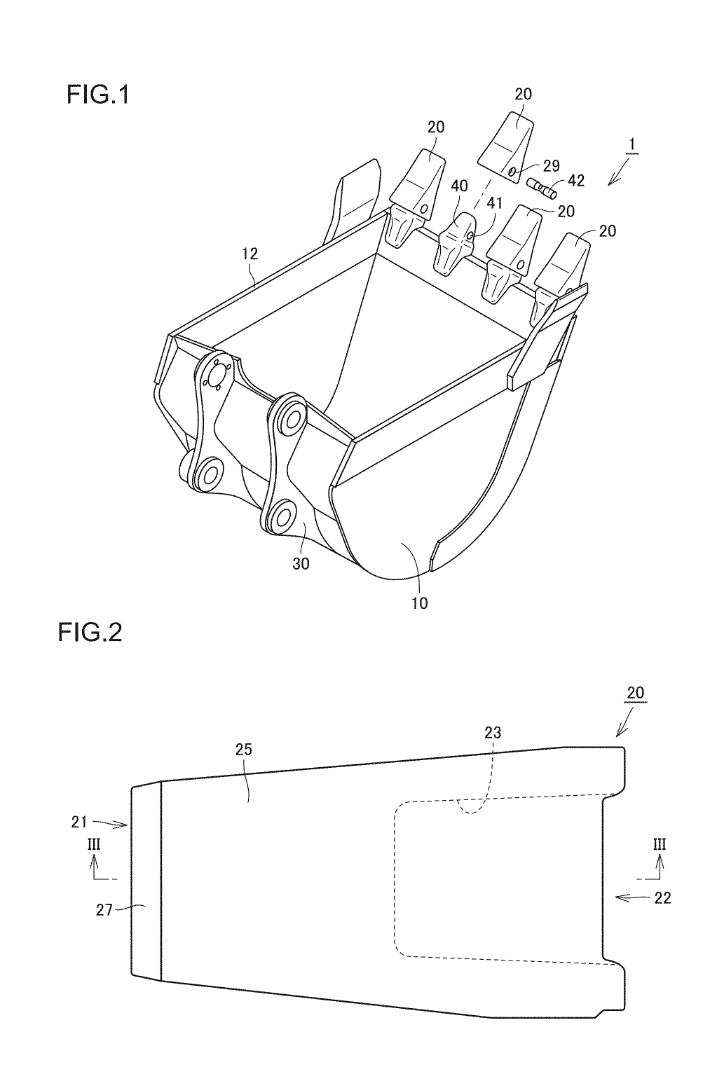

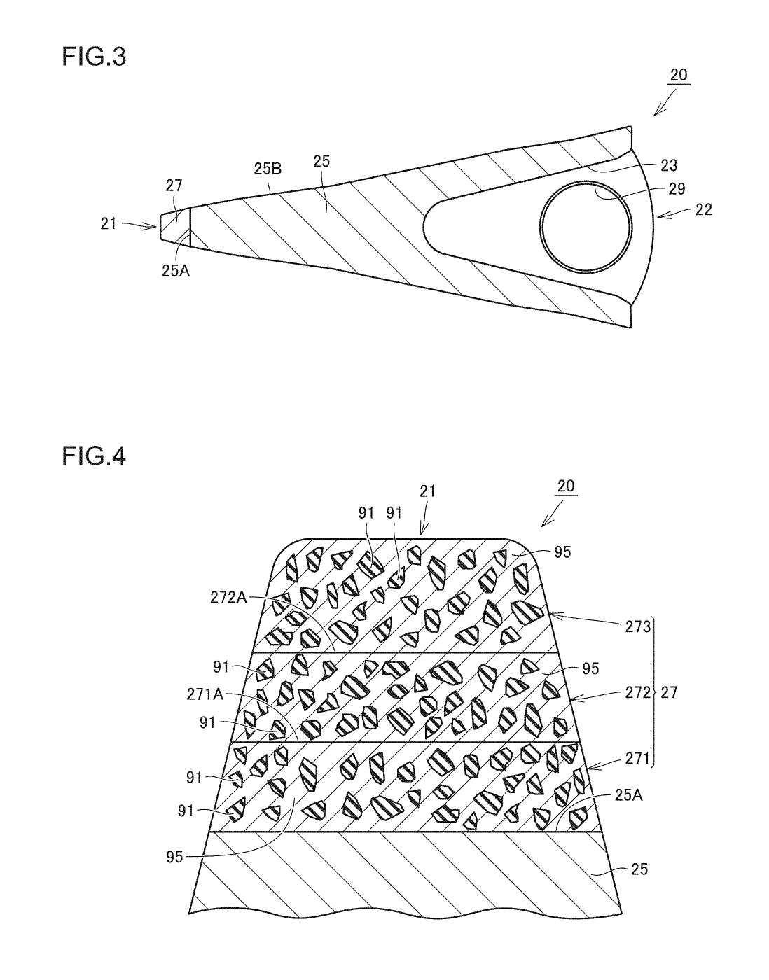

An earth and sand abrasion resistant component according to the present embodiment will be described by giving as an example a bucket tooth of a hydraulic excavator. FIG. 1 is a schematic perspective view showing the structure of a bucket of a hydraulic excavator. FIG. 2 is a schematic plan view showing the structure of a tooth. FIG. 3 is a schematic cross-sectional view taken along the line in FIG. 2.

Referring to FIG. 1, a bucket 1 is attached to a distal end of an arm (not shown) of a hydraulic excavator and operative to excavate earth and sand. The bucket 1 includes: a main body 10, made up of a plate-like member and having an opening; a plurality of (in the present embodiment, four) adapters 40 disposed so as to partially protrude from a periphery 12 of the opening of the main body 10 on its excavating side; a plurality of (in the present embodiment, four) teeth 20 attached to the corresponding adapters 40 to protrude from the periphery 12 of the opening on its excavating side; and a mounting portion 30 disposed on a side of the main body 10 opposite to the side where the teeth 20 are attached.

The adapters 40 are attached to the periphery 12 of the opening on its excavating side by welding, for example. Each tooth 20 is fitted onto the protruding portion of the corresponding adapter 40 and secured by a pin 42. Each adapter 40 has a through hole 41 formed to extend in a direction along the periphery of the opening, perpendicular to the protruding direction of the adapter. Each tooth 20 has a through hole 29 formed in a region corresponding to the through hole 41 of the adapter 40. The tooth 20 is secured to the adapter 40 as the pin 42 is inserted to penetrate through the through holes 41 and 29.

The bucket 1 is supported by the arm of the hydraulic excavator via the mounting portion 30. When the bucket 1 is used for excavation, the teeth 20 penetrate into earth and sand first. The teeth 20 are thus required to have high earth and sand abrasion resistance. The teeth 20 are earth and sand abrasion resistant components that are machine components used for applications where they come into contact with earth and sand.

Referring to FIGS. 2 and 3, a tooth 20 includes a distal end 21 and a proximal end 22. The tooth 20 has a cavity 23 formed on the proximal end 22 side. The tooth 20 is secured to the adapter 40 in the state where the protruding portion of the adapter 40 is inserted into the cavity 23. This causes the distal end 21 side to protrude from the periphery 12 of the opening of the bucket 1. The bucket 1 penetrates into earth and sand from the distal end 21 side of the teeth 20. The distal end 21 side of the teeth 20 therefore requires particularly high earth and sand abrasion resistance.

A tooth 20 includes a base 25 and an overlay 27. The base 25 is made of steel or cast iron and has a wedge shape. At a distal end of the base 25, a distal end face 25A is formed as a covered region. The overlay 27 is formed on the distal end face 25A. Of the surface of the base 25, the region other than the distal end face 25A constitutes an exposed region on which no overlay 27 is formed. For the material constituting the base 25, carbon steel for machine structural use or alloy steel for machine structural use specified in JIS standard (for example, S45C or SCM435, as well as manganese steel (SMn), chromium steel (SCr), chromium molybdenum steel (SCM), or nickel chromium molybdenum steel (SNCM) containing an equivalent amount of carbon), tool steel, or cast steel, for example, can be adopted.

The overlay 27 will now be described in detail with reference to FIG. 4. The overlay 27 formed on the distal end face 25A of the base 25 includes a first overlay layer 271, a second overlay layer 272, and a third overlay layer 273. The first overlay layer 271 is disposed directly on the distal end face 25A of the base 25. The second overlay layer 272 is disposed directly on the first overlay layer 271. As seen from the first overlay layer 271, the second overlay layer 272 is disposed on a side opposite to the base 25. The third overlay layer 273 is disposed directly on the second overlay layer 272. As seen from the second overlay layer 272, the third overlay layer 273 is disposed on a side opposite to the first overlay layer 271. A region of the third overlay layer 273 on a side opposite to the second overlay layer 272 constitutes the distal end 21 of the tooth 20.

The first overlay layer 271, the second overlay layer 272, and the third overlay layer 273 each include a matrix 95 made of iron or steel, and cermet particles 91 (hard particles) dispersed in the matrix 95. The cermet particles 91 may be, for example, crushed particles obtained by crushing used throwaway tips made of cermet. The cermet particles 91 may have a particle diameter of not less than 0.2 mm and not more than 3.5 mm, for example.

In the tooth 20 as the earth and sand abrasion resistant component in the present embodiment, the overlay 27 is made up of a plurality of stacked layers (first overlay layer 271, second overlay layer 272, and third overlay layer 273), and cermet particles 91 are adopted as the hard particles. With the cermet particles 91 being adopted as the hard particles, the hard cermet particles 91 are dispersed in the overlay 27, and the amount of the constituent elements (Ti, C, N) eluted into the matrix 95 is reduced as compared to the case where cemented carbide particles are adopted as the hard particles. Accordingly, the matrix 95 of the overlay 27, including cermet particles 91 adopted as the hard particles, is superior in toughness, although its hardness is low as compared to the matrix of the overlay including cemented carbide particles adopted as the hard particles.

Further, as the amount of the constituent elements eluted into the matrix 95 is small, the decrease in hardness of the cermet particles 91 is small. Specifically, in the overlay 27, the cermet particles 91 maintain a hardness of about 1500 HV. Therefore, in the case of forming a plurality of layers of overlay 27 (first overlay layer 271, second overlay layer 272, and third overlay layer 273) adopting cermet particles 91 as the hard particles, although the increase in hardness of the matrix 95 is small, the matrix 95 offers excellent toughness and the decrease in hardness of the cermet particles 91 as the hard particles is restricted. As a result, while the contribution of the matrix 95 to the earth and sand abrasion resistance does not increase considerably, occurrence of chipping of the overlay 27 or the like during the use of the tooth 20 is suppressed. With the decrease in hardness prevented, the cermet particles 91 as the hard particles contribute significantly to earth and sand abrasion resistance. Furthermore, cracking of the overlay 27 during the formation of the overlay 27 due to elution of the constituent elements into the matrix is also suppressed.

As described above, the tooth 20 in the present embodiment is an earth and sand abrasion resistant component that offers improved earth and sand abrasion resistance by virtue of the cermet particles 91 adopted as the hard particles and the overlay 27 made up of a plurality of layers (first overlay layer 271, second overlay layer 272, and third overlay layer 273). With embrittlement of the matrix 95 being prevented, the number of layers constituting the overlay 27 can readily be increased to further improve the earth and sand abrasion resistance. As the increase in hardness of the matrix 95 is restricted, alloy components may be added to the matrix 95, for example, whereby the hardness of the matrix 95 can readily be controlled to a desired level. Such addition of alloy elements to the matrix 95 may be implemented, for example, by changing the component composition of the welding wire used in overlaying welding (described later), or by adding alloy components from the outside during the overlaying welding.

The tooth 20 according to the present embodiment is therefore an earth and sand abrasion resistant component that is highly resistant to earth and sand abrasion.

It should be noted that in a region of the tooth 20 including an interface between neighboring overlay layers (region including the interface between the first overlay layer 271 and the second overlay layer 272, and region including the interface between the second overlay layer 272 and the third overlay layer 273), the matrix 95 preferably has a Vickers hardness that is not more than a half of the Vickers hardness of the cermet particles 91. By restricting the Vickers hardness of the matrix 95 to a half or less of that of the cermet particles 91, the toughness of the matrix 95 can further be improved.

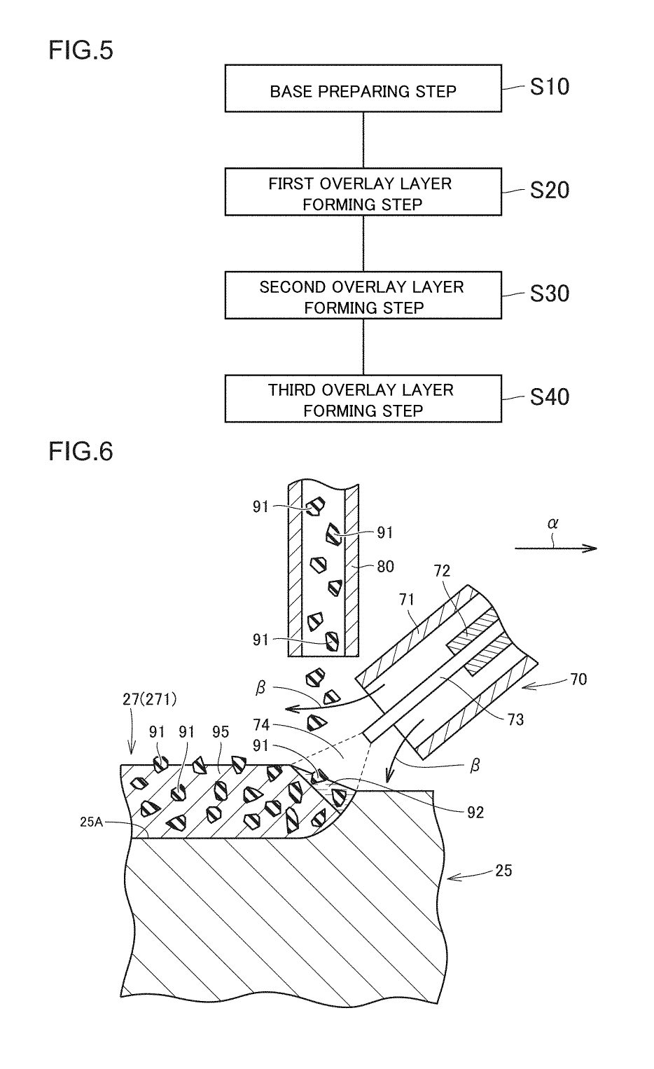

A method for producing a tooth 20 as the earth and sand abrasion resistant component in the present embodiment will now be described with reference to FIGS. 2 to 6. FIG. 5 is a flowchart schematically illustrating the tooth producing method. FIG. 6 is a schematic cross-sectional view illustrating an overlay forming method.

Referring to FIG. 5, in the method for producing a tooth 20 in the present embodiment, firstly, a base preparing step is carried out as a step S10. In this step S10, referring to FIGS. 2 and 3, a base 25 of the tooth 20 is prepared. For preparing the base 25, a steel member made of a steel constituting the base 25 is formed through forging, casting, cutting, or other processing, and then subjected to appropriate heat treatment (for example, quenching and tempering) as necessary.

Next, a first overlay layer forming step, a second overlay layer forming step, and a third overlay layer forming step are carried out successively as steps S20, S30 and S40. In the step S20, the first overlay layer 271 is formed on a distal end face 25A of the base 25 by overlaying welding. In the step S30, the second overlay layer 272 is formed on the first overlay layer 271 by overlaying welding. In the step S40, the third overlay layer 273 is formed on the second overlay layer 272 by overlaying welding.

The overlay 27 can be formed, for example, by overlaying welding using a metal inert gas (MIG) welding method as follows. Although a way of forming the first overlay layer 271 will be described below, the second overlay layer 272 and the third overlay layer 273 can be formed in a similar manner as the first overlay layer 271.

Firstly, an overlay forming device will be described. Referring to FIG. 6, the overlay forming device includes a welding torch 70 and a hard particles supplying nozzle 80. The welding torch 70 includes a welding nozzle 71 having a hollow cylindrical shape, and a contact tip 72 disposed inside the welding nozzle 71 and connected to a power source (not shown). A welding wire 73, while being in contact with the contact tip 72, is supplied continuously to the tip end side of the welding nozzle 71. For the welding wire, JIS YGW12, for example, may be adopted. A gap between the welding nozzle 71 and the contact tip 72 is a flow path of shielding gas. The shielding gas flowing through the flow path is discharged from the tip end of the welding nozzle 71. The hard particles supplying nozzle 80 has a hollow cylindrical shape. Inside the hard particles supplying nozzle 80, cermet particles 91 are supplied, which are discharged from the tip end of the hard particles supplying nozzle 80.

This overlay forming device can be used to form an overlay 27 (first overlay layer 271) in the following manner. With the base 25 as one electrode and the welding wire 73 as another electrode, voltage is applied across the base 25 and the welding wire 73. This generates an arc 74 between the welding wire 73 and the base 25. The arc 74 is shielded from the ambient air by the shielding gas discharged from the tip end of the welding nozzle 71 along the arrows β. For the shielding gas, argon, for example, may be adopted. The heat in the arc 74 melts a part of the base 25 and also melts the tip end of the welding wire 73. The tip end of the welding wire 73 thus molten forms droplets, which transfer to the molten region of the base 25. This forms a molten pool 92 which is a liquid region where the molten base 25 and the molten welding wire 73 are mixed together. The cermet particles 91 discharged from the hard particles supplying nozzle 80 are supplied to this molten pool 92.

As the welding torch 70 and the hard particles supplying nozzle 80 constituting the overlaying welding device move relatively in the direction shown by the arrow α with respect to the base 25, the position where the molten pool 92 is formed moves accordingly. The molten pool 92 previously formed solidifies, resulting in a first overlay layer 271. The first overlay layer 271 includes a matrix 95 formed by solidification of the molten pool 92, and cermet particles 91 dispersed in the matrix 95. Through the above procedure, the first overlay layer 271 is formed to cover the distal end face 25A which is the covered region on the surface of the base 25. The surface of the base 25 on which no first overlay layer 271 has been formed is an exposed region 25B. It should be noted that overlaying welding may be carried out, for example, under the following conditions: welding current of 250 A, welding voltage of 26.5 V, hard particles feed rate of 80 g/min, and welding speed of 2.0 mm/sec.

Following the formation of the first overlay layer 271 as described above, the second overlay layer 272 and the third overlay layer 273 are formed one on another in a similar manner, whereby the tooth 20 in the present embodiment is completed. After the first overlay layer 271, the second overlay layer 272, and the third overlay layer 273 are formed, heat treatment such as quenching may be performed.

### EXAMPLES

A device similar to the overlay forming device explained in the above embodiment was used to form a first overlay layer 271, a second overlay layer 272, and a third overlay layer 273 in a stacked manner, and an experiment was conducted to examine the properties. The experimental procedure was as follows.

A plate of SS400 (mild steel) was prepared as a base member, and a first overlay layer 271, a second overlay layer 272, and a third overlay layer 273 were formed, stacked on the plate. As the welding wire 73, JIS YGW12 (with a diameter of 1.2 mm) was adopted. As the hard particles, cermet particles 91 (crushed particles of waste cermet tips, with a particle diameter of 0.71 to 2.36 mm) were adopted. The welding current was 225 A, the welding voltage was 26 V, the shielding gas was argon (Ar), and the cermet particles were supplied at a rate of 80 g/min. The welding speeds of three levels of 3.8 mm/sec, 2.9 mm/sec, and 2.3 mm/sec were adopted. These welding speeds correspond to heat inputs of 15. 4 kJ/cm, 20.2 kJ/cm, and 25.4 kJ/cm, respectively. The obtained samples were observed in terms of appearance and cross section, and checked for cracking or the like. Further, hardness distribution was examined in the direction (thickness direction) of stacked layers of the overlay. A sample for comparison was prepared adopting cemented carbide particles instead of the cermet particles 91 (at a welding speed of 2.3 mm/sec), and the appearance and hardness distribution of the sample were examined in a similar manner. Further, hardness of the hard particles and that of the matrix surrounding the particles, in the case of the welding speed of 2.3 mm/sec, were measured.

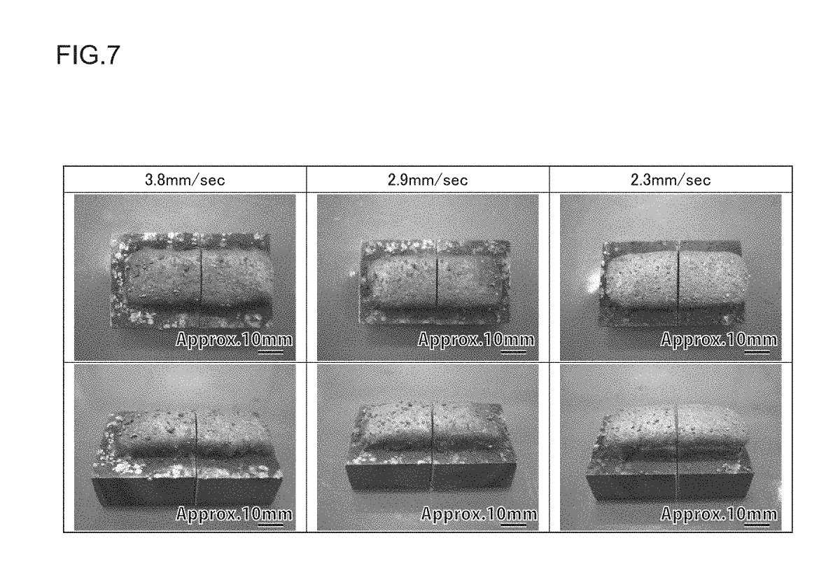

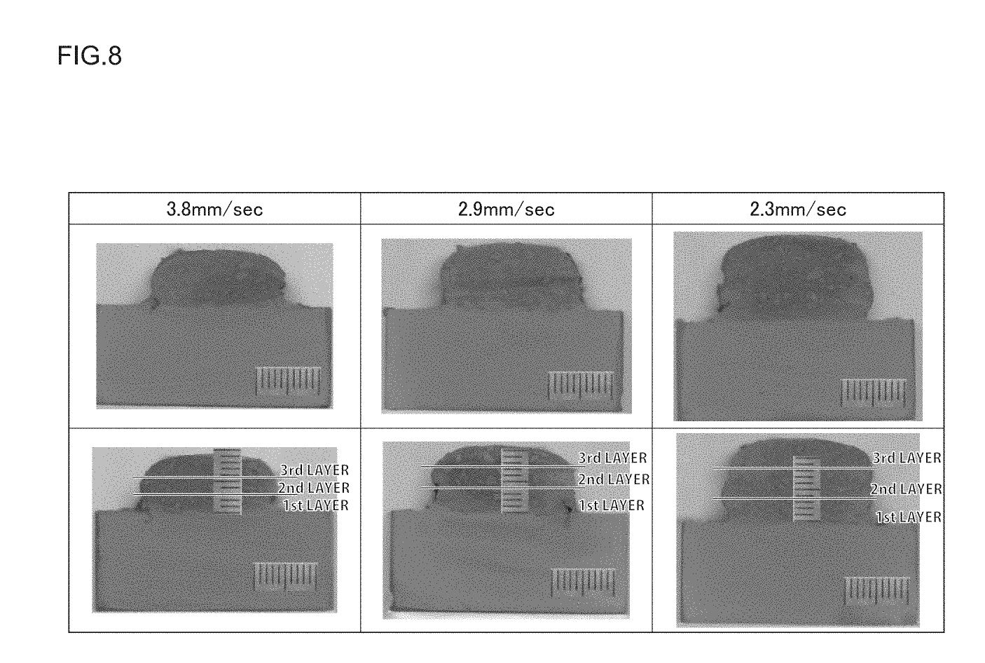

FIG. 7 includes photographs showing an appearance of the overlays in the case where cermet particles 91 were adopted as the hard particles. FIG. 8 includes photographs showing a cross section along a thickness direction of the overlays when the cermet particles 91 were adopted as the hard particles. Referring to FIGS. 7 and 8, in the case of adopting the cermet particles 91 as the hard particles, even when three layers of overlay were formed, no cracking or the like was confirmed irrespective of the welding speed. It is thus confirmed that a favorable overlay can be formed.

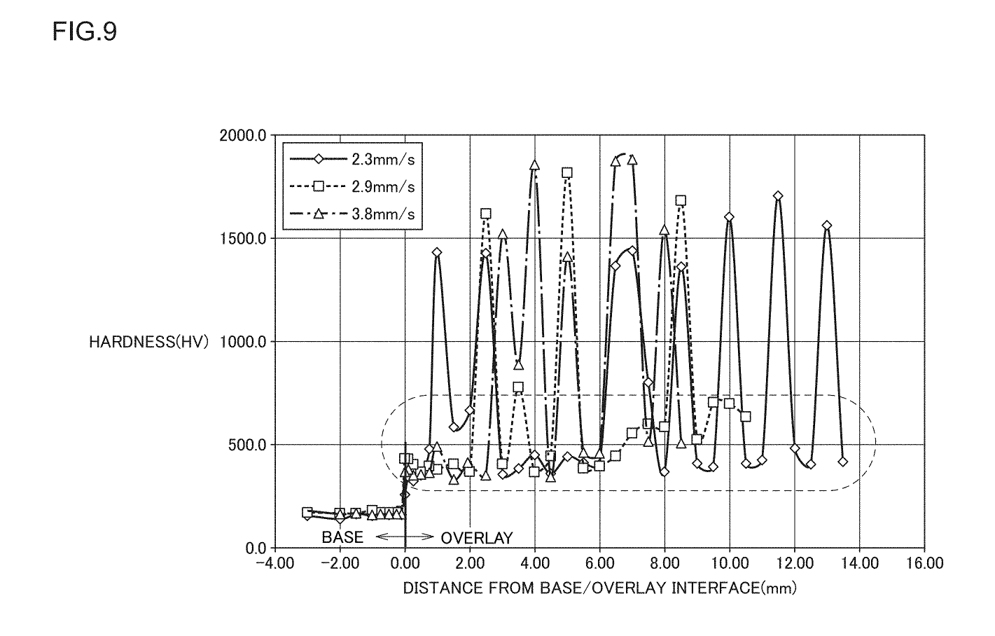

FIG. 9 illustrates hardness distribution in the thickness direction of the overlays. In FIG. 9, the horizontal axis represents distance from an interface between the base and the overlay, with the overlay side indicated by positive values. In FIG. 9, the vertical axis represents Vickers hardness.

Referring to FIG. 9, marks in the region constituting the baseline (delimited by the broken line) correspond to the hardness of the matrix. As is apparent from FIG. 9, in the case where cermet particles 91 were adopted as the hard particles, the hardness of the matrix has become about 500 HV. On the other hand, marks in the region where the hardness is high in FIG. 9 correspond to the hardness of the cermet particles as the hard particles. As is apparent from FIG. 9, the cermet particles have maintained a hardness of about 1500 HV or higher. The Vickers hardness of the matrix is a half or less of the Vickers hardness of the hard particles (cermet particles).

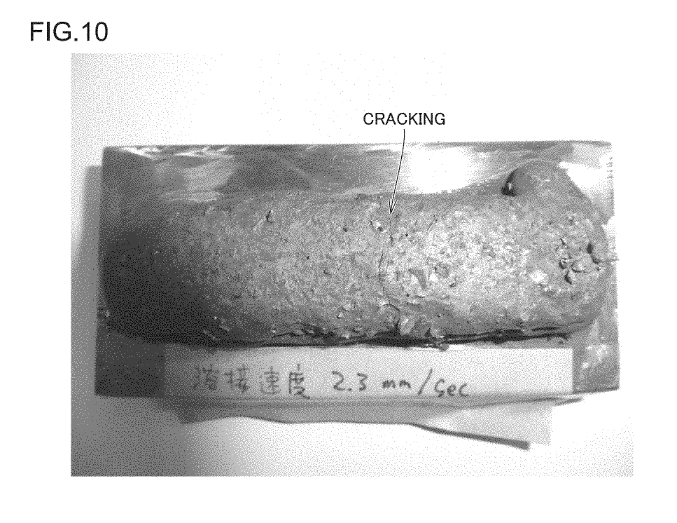

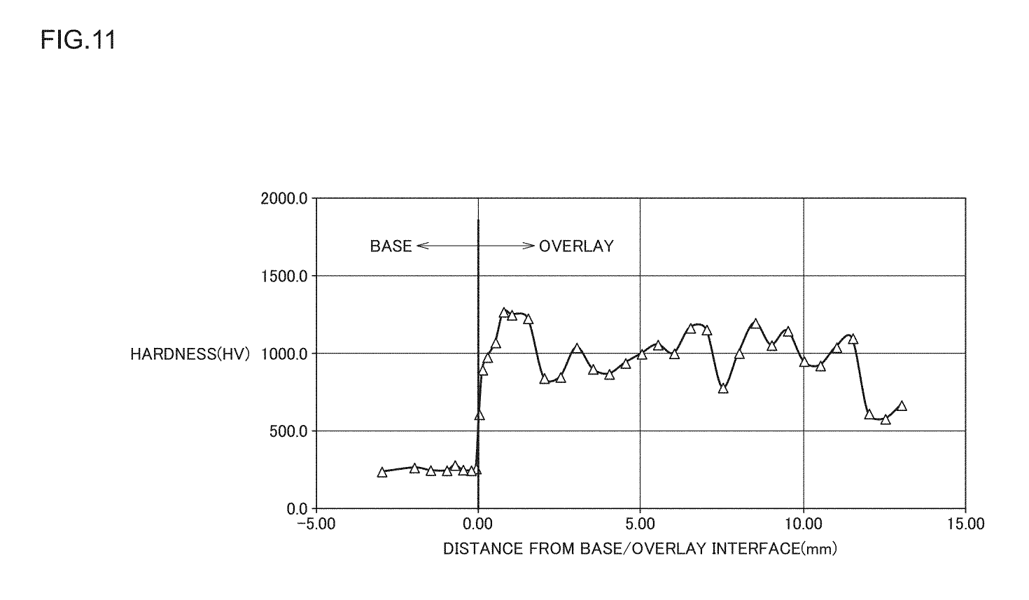

FIG. 10 is a photograph showing an appearance of the overlay in the case where cemented carbide particles were adopted as the hard particles. FIG. 11, corresponding to FIG. 9 above, illustrates hardness distribution in the thickness direction of the overlay when the cemented carbide particles were adopted as the hard particles.

Referring to FIG. 10, in the case where three overlay layers were formed adopting cemented carbide particles as the hard particles, occurrence of cracking was confirmed. Further, referring to FIG. 11, when the cemented carbide particles were adopted as the hard particles, while the hardness of the matrix has increased to about 700 to 800 HV, the hardness of the cemented carbide particles as the hard particles has decreased to about 1000 to 1300 HV.

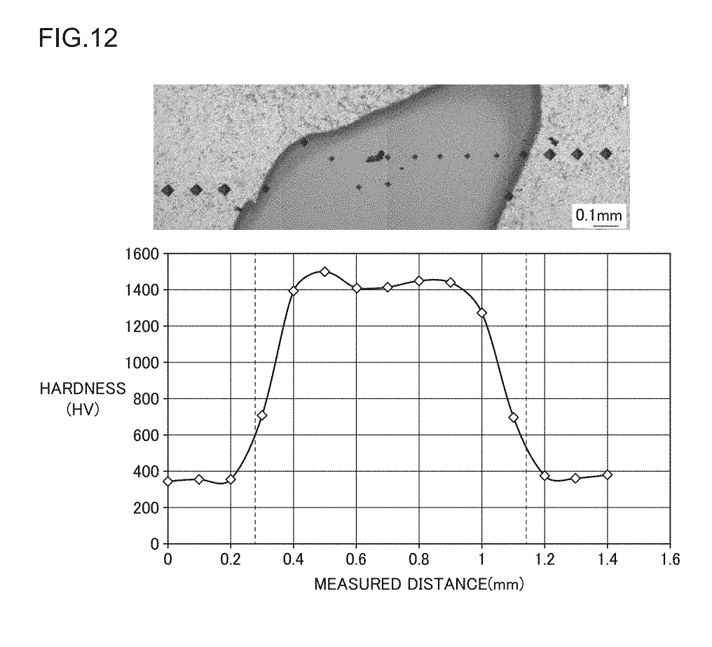

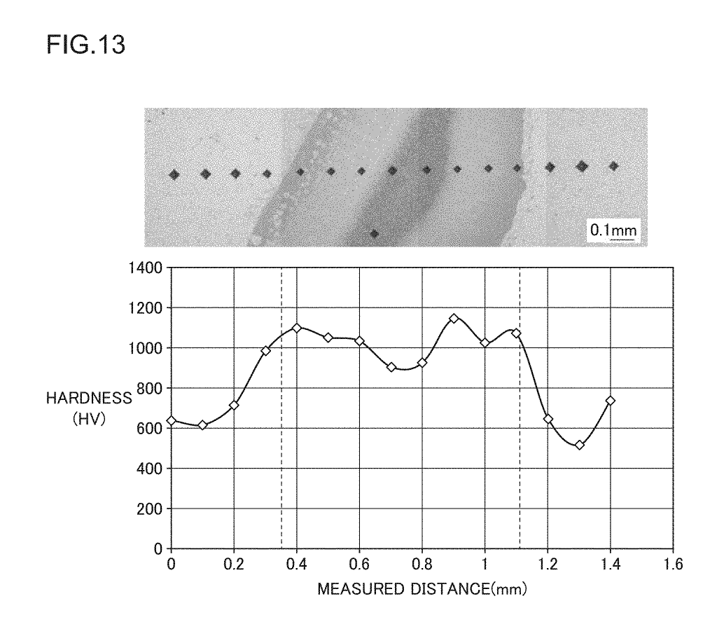

FIGS. 12 and 13 each show, in combination, an optical micrograph of a hard particle and a matrix surrounding the particle and hardness distribution in the region corresponding to the field of view of the optical micrograph, the figures corresponding respectively to the cases where cermet particles and cemented carbide particles were adopted as the hard particles. In the optical micrographs in FIGS. 12 and 13, a cermet particle and a cemented carbide particle are respectively observed at the center. In the hardness distribution diagrams in FIGS. 12 and 13, the broken lines represent the interface between the hard particle and the matrix.

Referring to FIG. 12, the cermet particle within the overlay formed by overlaying welding as described above maintains a hardness of about 1400 to 1500 HV. The hardness of the matrix surrounding the cermet particle is 400 HV or less. This is conceivably because the amount of the constituent elements eluted from the cermet particle into the matrix is small.

Referring to FIG. 13, the hardness of the cemented carbide particle within the overlay formed by overlaying welding as described above has decreased to about 900 to 1200 HV. The hardness of the matrix surrounding the cemented carbide particle has increased to 600 HV or more. This is conceivably because the amount of the constituent elements eluted from the cemented carbide particle into the matrix is large as compared to the eluted amount of the constituent elements of the cermet particle into the matrix.

The above experimental results confirm that, in the case where cemented carbide is adopted as the material constituting the hard particles, the constituent elements would likely be eluted into the matrix, causing an increase in hardness of the matrix and a decrease in hardness of the hard particles. Therefore, even when two or more overlay layers are formed adopting cemented carbide as the material constituting the hard particles, it would not lead to improved earth and sand abrasion resistance. Further, it is considered that the constituent elements eluted into the matrix in a large amount have caused cracking in the overlay.

In contrast, it is confirmed that, in the case where cermet is adopted as the material constituting the hard particles, elution of the constituent elements into the matrix is reduced, so toughness of the matrix is maintained and a decrease in hardness of the hard particles is prevented. Therefore, forming two or more overlay layers adopting cermet as the material constituting the hard particles leads to improved earth and sand abrasion resistance. Further, with elution of the constituent elements into the matrix being suppressed, it is readily possible to form a favorable overlay with no cracking.

The above experimental results confirm that, according to the earth and sand abrasion resistant component and its producing method of the present invention, it is possible to provide an earth and sand abrasion resistant component that is highly resistant to earth and sand abrasion.

While a tooth used for a bucket of a hydraulic excavator or the like has been described as an example of the earth and sand abrasion resistant component of the present invention in the above embodiment, the earth and sand abrasion resistant component according to the present invention is not limited to such a tooth. The earth and sand abrasion resistant component according to the present invention is applicable to various earth and sand abrasion resistant components requiring high resistance to earth and sand abrasion, which for example include: a shoe constituting a tracked undercarriage; a cutting edge and protector of a bucket; a variety of wear plates and liners; as well as components constituting underground construction equipment (shield machines, tunnel boring machines, etc.), crushing machines, rock splitters, cement machines, steelmaking machines, casting machines, and so on.

It should be understood that the embodiment and examples disclosed herein are illustrative and non-restrictive in every respect. The scope of the present invention is defined by the terms of the claims, rather than the description above, and is intended to include any modifications within the scope and meaning equivalent to the terms of the claims.

### INDUSTRIAL APPLICABILITY

The earth and sand abrasion resistant component and its producing method according to the present invention are applicable particularly advantageously to an earth and sand abrasion resistant component requiring high earth and sand abrasion resistance and to its producing method.

### DESCRIPTION OF REFERENCE NUMERALS

1: bucket; 10: main body; 12: periphery of opening; 20: tooth; 21: distal end; 22: proximal end; 23: cavity; 25: base; 25A: distal end face; 25B: exposed region; 27: overlay; 271: first overlay layer; 272: second overlay layer; 273: third overlay layer; 29: through hole; 30: mounting portion; 40: adapter; 41: through hole; 42: pin; 70: welding torch; 71: welding nozzle; 72: contact tip; 73: welding wire; 74: arc; 80: hard particles supplying nozzle; 91: cermet particle; 92: molten pool; and 95: matrix.

1. An earth and sand abrasion resistant component, comprising:
a base;
a first overlay layer disposed in contact with the base so as to cover a covered region being a part of a surface of the base; and
a second overlay layer disposed on the first overlay layer;
the first overlay layer and the second overlay layer each including
a matrix made of iron or steel, and
hard particles made of cermet and dispersed in the matrix.

2. The earth and sand abrasion resistant component according to claim 1, wherein in a region including an interface between the first overlay layer and the second overlay layer, the matrix has a Vickers hardness that is not more than a half of a Vickers hardness of the hard particles.

3. The earth and sand abrasion resistant component according to claim 1, wherein
the earth and sand abrasion resistant component is a tooth, and
the covered region is located in a region in the base corresponding to a distal end portion of the tooth.

4. A method for producing an earth and sand abrasion resistant component, comprising the steps of:
preparing a base;
forming a first overlay layer to cover a covered region being a part of a surface of the base; and
forming a second overlay layer on the first overlay layer;
the step of forming the first overlay layer and the step of forming the second overlay layer including forming, by overlaying welding, the first overlay layer and the second overlay layer each including a matrix made of iron or steel and hard particles made of cermet and dispersed in the matrix.

5. The earth and sand abrasion resistant component according to claim 2, wherein
the earth and sand abrasion resistant component is a tooth, and
the covered region is located in a region in the base corresponding to a distal end portion of the tooth.
